(19) United States
(12) Patent Application Publication
(10) Pub. No.: US 2022/0097434 A1
(43) Pub. Date: Mar. 31, 2022

(54) THREE-DIMENSIONAL OBJECT PRINTING APPARATUS AND THREE-DIMENSIONAL OBJECT PRINTING METHOD

(71) Applicant: Seiko Epson Corporation, Tokyo (JP)

(72) Inventors: Keigo SUGAI, Chino-shi (JP); Kenju MOCHIZUKI, Azumino-shi (JP); Kohei UTSUNOMIYA, Matsumoto-shi (JP)

(21) Appl. No.: 17/486,353

(22) Filed: Sep. 27, 2021

(30) Foreign Application Priority Data
Sep. 29, 2020 (JP) 2020-163788

(51) Int. Cl. B41J 29/393; B41J 3/407

(52) U.S. Cl. CPC B41J 29/393; B41J 3/4073

(57) ABSTRACT

A three-dimensional object printing apparatus includes a liquid discharge head that discharges a liquid to a three-dimensional workpiece, a moving mechanism that changes a position of the liquid discharge head relative to the workpiece, and a detection section that detects the position of the liquid discharge head relative to the workpiece, in which the apparatus executes a first detection operation in which the detection section detects a position on the first scanning path while the moving mechanism causes the liquid discharge head to scan relative to the workpiece along a first scanning path, and a first printing operation in which the liquid discharge head discharges the liquid to a first region of the workpiece while the moving mechanism causes the liquid discharge head to scan relative to the workpiece along a second scanning path based on a detection result by the detection section in the first detection operation.

The present application is based on, and claims priority from JP Application Serial Number 2020-163788, filed Sep. 29, 2020, the disclosure of which is hereby incorporated by reference herein in its entirety.

### BACKGROUND

### 1. Technical Field

The present disclosure relates to a three-dimensional object printing apparatus and a three-dimensional object printing method.

### 2. Related Art

A three-dimensional object printing apparatus is known in which an ink jet print head is moved by a combination of operations of a plurality of movable portions to print on the surface of a three-dimensional object by an ink jet method. For example, the apparatus described in JP-A-2014-111307 includes a robot arm having a plurality of movable portions, an ink jet print head attached to the tip of the robot arm, and a controller for controlling the movement of the robot arm. Here, the controller controls the movement of the robot arm so that the ink jet print head follows a series of scanning paths.

When the ink jet print head is linearly moved along a scanning path by a combination of operations of the plurality of movable portions, the following problems may occur. Even if the controller is simply given an ideal path as an instruction of the path along which the ink jet print head should move, since the operation error of each joint portion appears at various timings in the middle of the scanning path, there is a problem that an actual path meanders and deviates from the ideal path, resulting in deterioration of printing image quality.

### SUMMARY

According to an aspect of the present disclosure, there is provided a three-dimensional object printing apparatus including a liquid discharge head that discharges a liquid to a three-dimensional workpiece, a moving mechanism that changes a position of the liquid discharge head relative to the workpiece or an object corresponding to the workpiece, and a detection section that detects the position of the liquid discharge head relative to the workpiece or the object, in which the apparatus executes a first detection operation in which the detection section detects a position on the first scanning path while the moving mechanism causes the liquid discharge head to scan relative to the workpiece or the object along a first scanning path, and a first printing operation in which the liquid discharge head discharges the liquid to a first region of the workpiece while the moving mechanism causes the liquid discharge head to scan relative to the workpiece along a second scanning path based on a detection result by the detection section in the first detection operation.

According to another aspect of the present disclosure, there is provided a three-dimensional object printing apparatus including a liquid discharge head that discharges a liquid to a three-dimensional workpiece, a moving mechanism that changes a position of the liquid discharge head relative to the workpiece or an object corresponding to the workpiece, and a detection section that detects the position of the liquid discharge head relative to the workpiece or the object, in which the apparatus executes a first detection operation in which the detection section detects a position on the first scanning path while the moving mechanism causes the liquid discharge head to scan relative to the workpiece or the object along a first scanning path, and a first printing operation in which the liquid discharge head discharges the liquid to a first region of the workpiece while the moving mechanism causes the liquid discharge head to scan relative to the workpiece along a second scanning path, when a deviation amount of the first scanning path with respect to a reference path is a first amount, a path difference between the first scanning path and the second scanning path is a first path difference, and when the deviation amount is a second amount larger than the first amount, the path difference is a second path difference larger than the first path difference.

According to still another aspect of the present disclosure, there is provided a three-dimensional object printing method for printing on a three-dimensional workpiece by using a liquid discharge head that discharges a liquid to the workpiece and a moving mechanism that changes a position of the liquid discharge head relative to the workpiece or an object corresponding to the workpiece, the method including executing a first detection operation of detecting a position on the first scanning path while the moving mechanism causes the liquid discharge head to scan relative to the workpiece or the object along a first scanning path, and executing a first printing operation in which the liquid discharge head discharges the liquid to a first region of the workpiece while the moving mechanism causes the liquid discharge head to scan relative to the workpiece along a second scanning path based on a detection result by the detection section in the first detection operation.

According to still another aspect of the present disclosure, there is provided a three-dimensional object printing method for prints on a three-dimensional workpiece by using a liquid discharge head that discharges a liquid to the workpiece and a moving mechanism that changes a position of the liquid discharge head relative to the workpiece or an object corresponding to the workpiece, the method including executing a first detection operation of detecting a position on the first scanning path while the moving mechanism causes the liquid discharge head to scan relative to the workpiece or the object along a first scanning path, and executing a first printing operation in which the liquid discharge head discharges the liquid to a first region of the workpiece while the moving mechanism causes the liquid discharge head to scan relative to the workpiece along a second scanning path, in which when a deviation amount of the first scanning path with respect to a reference path is a first amount, a path difference between the first scanning path and the second scanning path is a first path difference, and when the deviation amount is a second amount larger than the first amount, the path difference is a second path difference larger than the first path difference.

### BRIEF DESCRIPTION OF THE DRAWINGS

FIG. 1 is a perspective view illustrating an outline of a three-dimensional object printing apparatus according to a first embodiment.

FIG. 2 is a block diagram illustrating an electrical configuration of the three-dimensional object printing apparatus according to the first embodiment.

FIG. 3 is a perspective view illustrating a schematic configuration of a liquid discharge head unit according to the first embodiment.

FIG. 4 is a sectional view illustrating a configuration example of the liquid discharge head according to the first embodiment.

FIG. 5 is a flowchart illustrating a flow of a three-dimensional object printing method according to the first embodiment.

FIG. 6 is a flowchart illustrating a flow of generating point data illustrated in FIG. 5.

FIG. 7 is a diagram illustrating a detection operation and a printing operation according to the first embodiment.

FIG. 8 is a diagram illustrating point data illustrating an ideal scanning path.

FIG. 9 is a diagram illustrating the detection of a position on an actual scanning path when the point data indicating the ideal scanning path is used.

FIG. 10 is a diagram illustrating a deviation of the actual scanning path with respect to the ideal scanning path.

FIG. 11 is a diagram illustrating an example of point data corrected based on the actual scanning path.

FIG. 12 is a diagram illustrating another example of point data corrected based on the actual scanning path.

FIG. 13 is a diagram illustrating the actual scanning path when the corrected point data is used.

FIG. 14 is a diagram illustrating the detection of the actual scanning path in a subsequent pass.

FIG. 15 is a diagram illustrating a corrected scanning path in the subsequent pass.

FIG. 16 is a block diagram illustrating an electrical configuration of a three-dimensional object printing apparatus according to a second embodiment.

FIG. 17 is a diagram illustrating the detection of an actual scanning path according to the second embodiment.

### DESCRIPTION OF EXEMPLARY EMBODIMENTS

Hereinafter, preferred embodiments according to the present disclosure will be described with reference to the accompanying drawings. In the drawings, the dimensions or scales of each portion are appropriately different from the actual dimensions or scales, and some portions are schematically illustrated for easy understanding. The scope of the present disclosure is not limited to these embodiments unless otherwise particularly stated to limit the present disclosure in the following description.

The following description will be performed by using an X-axis, a Y-axis, and a Z-axis that intersect each other as appropriate. One direction along the X-axis is referred to as an X1 direction, and a direction opposite to the X1 direction is referred to as an X2 direction. Similarly, directions opposite to each other along the Y-axis are referred to as a Y1 direction and a Y2 direction. Directions opposite to each other along the Z-axis are referred to as a Z1 direction and a Z2 direction.

Here, the X-axis, the Y-axis, and the Z-axis are coordinate axes of a base coordinate system set in a space in which a workpiece W and a base 210 to be described later are installed. Typically, the Z-axis is a vertical axis, and the Z2 direction corresponds to a downward direction in a vertical direction. The Z-axis may not be a vertical axis. Although the X-axis, the Y-axis, and the Z-axis are typically orthogonal to each other, the present disclosure is not limited thereto, and the axes may not be orthogonal to each other. For example, the X-axis, Y-axis, and Z-axis may intersect each other at an angle within a range of 80° or more and 100° or less.

### 1. First Embodiment

### 1-1. Outline of Three-Dimensional Object Printing Apparatus

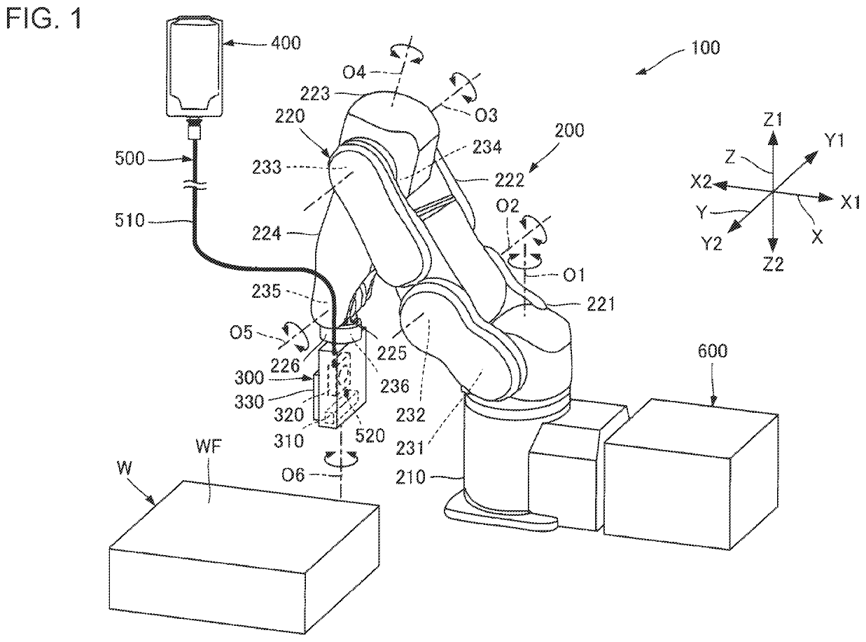

FIG. 1 is a perspective view illustrating an outline of a three-dimensional object printing apparatus 100 according to a first embodiment. The three-dimensional object printing apparatus 100 is an apparatus that prints on the surface of the three-dimensional workpiece W by an ink jet method.

The workpiece W has a surface WF as a printing target. In the example illustrated in FIG. 1, the workpiece W is a rectangular parallelepiped, and the surface WF is a plane facing the Z1 direction. The printing target may be a surface other than the surface WF among the plurality of surfaces of the workpiece W. The size, shape, or installation pose of the workpiece W is not limited to the example illustrated in FIG. 1, and is any size, shape, or installation pose.

Here, in a detection operation MD described later, an object O corresponding to the workpiece W is used if necessary. The object O is an object having a surface OF having substantially the same shape and pose as the surface WF. For example, the object O is an object having substantially the same shape as the workpiece W, and is installed in a pose substantially the same as the workpiece W, in place of the workpiece W. The object O may be a peelable film attached to the surface WF of the workpiece W. If necessary, the film is provided with a receiving layer for facilitating the absorption of ink.

In the example illustrated in FIG. 1, the three-dimensional object printing apparatus 100 is an ink jet printer using a vertical articulated robot. Specifically, as illustrated in FIG. 1, the three-dimensional object printing apparatus 100 includes a robot 200, a liquid discharge head unit 300, a liquid reservoir 400, a supply flow path 500, and a control device 600. Hereinafter, first, each portion of the three-dimensional object printing apparatus 100 will be briefly described in sequence.

The robot 200 is an example of a moving mechanism that changes a position and a pose of the liquid discharge head unit 300 with respect to the workpiece W. In the example illustrated in FIG. 1, the robot 200 is a so-called 6-axis vertical articulated robot. Specifically, the robot 200 has a base 210 and an arm 220.

The base 210 is a base that supports the arm 220. In the example illustrated in FIG. 1, the base 210 is fixed to an installation surface such as a floor surface facing the Z1 direction by screwing or the like. The installation surface to which the base 210 is fixed may be a surface facing any direction, but is not limited to the example illustrated in FIG. 1, and may be, for example, a surface of a wall, a ceiling, a movable carriage, or the like.

The arm 220 is a 6-axis robot arm having a base end attached to the base 210 and a tip of which a position and a pose is three-dimensionally changed with respect to the base end. Specifically, the arm 220 has arms 221, 222, 223, 224, 225, and 226, and these arms are coupled in this order.

The arm 221 is rotatably coupled to the base 210 around a first rotation axis O1 via a joint portion 231. The arm 222 is rotatably coupled to the arm 221 around a second rotation axis O2 via a joint portion 232. The arm 223 is rotatably coupled to the arm 222 around a third rotation axis O3 via a joint portion 233. The arm 224 is rotatably coupled to the arm 223 around a fourth rotation axis O4 via a joint portion 234. The arm 225 is rotatably coupled to the arm 224 around a fifth rotation axis O5 via a joint portion 235. The arm 226 is rotatably coupled to the arm 225 around a sixth rotation axis O6 via a joint portion 236.

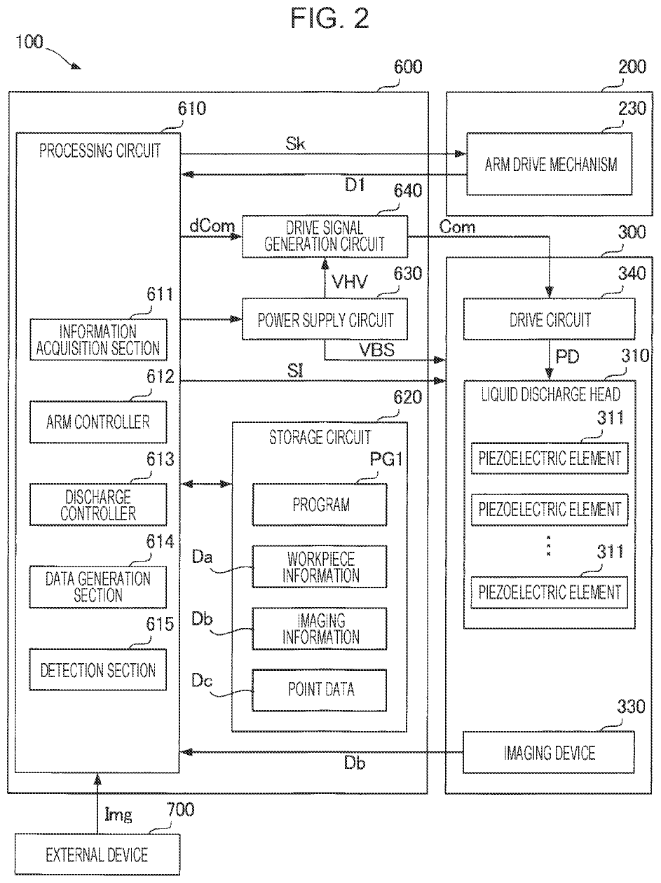

In the example illustrated in FIG. 1, each of the joint portions 231 to 236 is a mechanism for rotatably coupling one of two adjacent arms to the other arm. Although not illustrated, a drive mechanism for rotating one of two adjacent arms with respect to the other arm is provided in each of the joint portions 231 to 236. The drive mechanism includes, for example, a motor that generates a driving force for the rotation, a speed reducer that decelerates and outputs the driving force, and an encoder such as a rotary encoder that detects an angle of the rotation or the like. The drive mechanism corresponds to an arm drive mechanism 230 illustrated in FIG. 2 to be described later.

The first rotation axis O1 is an axis perpendicular to an installation surface (not illustrated) to which the base 210 is fixed. The second rotation axis O2 is an axis perpendicular to the first rotation axis O1. The third rotation axis O3 is an axis parallel to the second rotation axis O2. The fourth rotation axis O4 is an axis perpendicular to the third rotation axis O3. The fifth rotation axis O5 is an axis perpendicular to the fourth rotation axis O4. The sixth rotation axis O6 is an axis perpendicular to the fifth rotation axis O5.

As for these rotation axes, a case where one axis is “perpendicular” to the other axis includes a case where the angle formed by the two rotation axes is strictly 90° and a case where the angle formed by the two rotation axes deviates within a range of about 90° to ±5°. Similarly, a case where one axis is “parallel” to the other axis includes a case where the two rotation axes are strictly parallel and a case where one of the two rotation axes tilts with respect to the other axis within a range of about ±5°.

The liquid discharge head unit 300 is attached, as an end effector, to a tip of the arm 221, that is, the arm 226.

The liquid discharge head unit 300 is a mechanism having a liquid discharge head 310 that discharges ink which is an example of a liquid toward the workpiece W. In the present embodiment, the liquid discharge head unit 300 includes a pressure adjustment valve 320 that adjusts a pressure of the ink to be supplied to the liquid discharge head 310, and an imaging device 330 that images the surface WF of the workpiece W or the surface OF of the object O, in addition to the liquid discharge head 310. Since both the pressure adjustment valve and the imaging device are fixed to the arm 226, a relationship between the positions and the poses is fixed.

The liquid discharge head 310 will be described in detail later. The pressure adjustment valve 320 is a valve mechanism that opens and closes according to the pressure of the ink in the liquid discharge head 310. By this opening and closing, the pressure of the ink in the liquid discharge head 310 is maintained at a negative pressure within a predetermined range. Thus, a meniscus of the ink formed in the nozzle N of the liquid discharge head 310 is stabilized. As a result, it is possible to prevent air bubbles from entering the nozzle N and the ink from overflowing from the nozzle N.

The number of each of the liquid discharge head 310 and the pressure adjustment valve 320 included in the liquid discharge head unit 300 is one in the example illustrated in FIG. 1, but the number is not limited to the example illustrated in FIG. 1, and may be two or more. The installation position of the pressure adjustment valve 320 and the imaging device 330 is not limited to the arm 226, and may be, for example, another arm or the like, or may be a fixed position with respect to the base 210.

The imaging device 330 includes, for example, an imaging optical system and an imaging element. The imaging optical system is an optical system including at least one imaging lens, and may include various optical elements such as a prism, or may include a zoom lens, a focus lens, or the like. The imaging element is, for example, a charge coupled device (CCD) image sensor, a complementary MOS (CMOS) image sensor, or the like.

The liquid reservoir 400 is a container that reserves the ink. The liquid reservoir 400 is, for example, a bag-shaped ink pack made of a flexible film. The ink reserved in the liquid reservoir 400 is, for example, ink containing a coloring material such as a dye or a pigment. A type of the ink reserved in the liquid reservoir 400 is not limited to the ink containing the coloring material, and may be, for example, ink containing a conductive material such as metal powder. The ink may have curability such as ultraviolet curability. When the ink has the curability such as ultraviolet curability, for example, an ultraviolet irradiation mechanism is mounted on the liquid discharge head unit 300.

In the example illustrated in FIG. 1, the liquid reservoir 400 is fixed to a wall, a ceiling, a pillar, or the like such that the liquid reservoir is constantly positioned in the Z1 direction from the liquid discharge head 310. That is, the liquid reservoir 400 is positioned above a moving region of the liquid discharge head 310 in the vertical direction. Thus, the ink can be supplied from the liquid reservoir 400 to the liquid discharge head 310 with a predetermined pressing force without using a mechanism such as a pump.

The liquid reservoir 400 can be installed at a position such that the ink is supplied from the liquid reservoir 400 to the liquid discharge head 310 with a predetermined pressure, and the liquid reservoir may be positioned below the liquid discharge head 310 in the vertical direction. In this case, for example, the ink may be supplied from the liquid reservoir 400 to the liquid discharge head 310 at a predetermined pressure by using a pump.

The supply flow path 500 is a flow path for supplying the ink from the liquid reservoir 400 to the liquid discharge head 310. The pressure adjustment valve 320 is provided in the middle of the supply flow path 500. Thus, even though a positional relationship between the liquid discharge head 310 and the liquid reservoir 400 changes, a fluctuation in a pressure of the ink in the liquid discharge head 310 can be reduced.

The supply flow path 500 is divided into an upstream flow path 510 and a downstream flow path 520 by the pressure adjustment valve 320. That is, the supply flow path 500 has the upstream flow path 510 that communicatively couples the liquid reservoir 400 and the pressure adjustment valve 320, and the downstream flow path 520 that communicatively couples the pressure adjustment valve 320 and the liquid discharge head 310.

Each of the upstream flow path 510 and the downstream flow path 520 is formed by, for example, an internal space of a pipe body. Here, the pipe body used for the upstream flow path 510 is made of, for example, an elastic material such as a rubber material or an elastomer material, and has flexibility. As stated above, the upstream flow path 510 is formed by using the flexible pipe body, and thus, a change in the relative positional relationship between the liquid reservoir 400 and the pressure adjustment valve 320 is allowed. Accordingly, even though the position or the pose of the liquid discharge head 310 changes while the position and the pose of the liquid reservoir 400 are fixed, the ink can be supplied from the liquid reservoir 400 to the pressure adjustment valve 320. On the other hand, the pipe body used for the downstream flow path 520 may not have flexibility. Accordingly, the pipe body used for the downstream flow path 520 may be made of an elastic material such as a rubber material or an elastomer material, or may be made of a hard material such as a resin material.

A part of the upstream flow path 510 may be formed by a member having no flexibility. The downstream flow path 520 is not limited to the configuration using the pipe body. For example, a part or the entirety of the downstream flow path 520 may have a distribution flow path for distributing the ink from the pressure adjustment valve 320 to a plurality of locations, or may be integrally formed with the liquid discharge head 310 or the pressure adjustment valve 320.

The control device 600 is a device that controls the driving of each portion of the three-dimensional object printing apparatus 100. Here, the control device 600 is a robot controller that controls the driving of the liquid discharge head 310 and the robot 200. The control device 600 will be described in detail together with the following description of an electrical configuration of the three-dimensional object printing apparatus 100.

### 1-2. Electrical Configuration of Three-Dimensional Object Printing Apparatus

FIG. 2 is a block diagram illustrating an electrical configuration of the three-dimensional object printing apparatus 100 according to the first embodiment. FIG. 2 illustrates electrical components among the components of the three-dimensional object printing apparatus 100. As illustrated in FIG. 2, the control device 600 includes a processing circuit 610, a storage circuit 620, a power supply circuit 630, and a drive signal generation circuit 640.

A hardware configuration included in the control device 600 to be described below may be appropriately divided. For example, an arm controller 612 and the drive signal generation circuit 640 of the control device 600 may be provided separately in different hardware configurations. A part or all of the functions of the control device 600 may be realized by an external device 700 coupled to the control device 600, or may be realized by another external device such as a personal computer (PC) coupled to the control device 600 via a network such as a local area network (LAN) or the Internet.

The processing circuit 610 has a function of controlling an operation of each portion of the three-dimensional object printing apparatus 100 and a function of processing various data. The processing circuit 610 includes, for example, one or more processors such as a central processing unit (CPU). The processing circuit 610 may include a programmable logic device such as a field-programmable gate array (FPGA) instead of the CPU or in addition to the CPU.

The storage circuit 620 stores various programs such as a program PG1 executed by the processing circuit 610 and various data such as workpiece information Da, imaging information db, and point data Dc processed by the processing circuit 610. The storage circuit 620 includes, for example, one or both semiconductor memories of a volatile memory such as a random access memory (RAM) and a non-volatile memory such as a read only memory (ROM), an electrically erasable programmable read-only memory (EEPROM) or a programmable ROM (PROM). The storage circuit 620 may be formed as a part of the processing circuit 610.

The workpiece information Da is information indicating the position and shape of the surface WF of the workpiece W. The workpiece information Da is, for example, information in which information such as computer-aided design (CAD) data indicating the three-dimensional shape of the workpiece W is associated with the above-mentioned base coordinate system. Here, since the object O corresponds to the workpiece W as described above, the workpiece information Da can be said to be information indicating the position and shape of the surface OF of the object O. The workpiece information Da is generated by a data generation section 614 described later. The information indicating the three-dimensional shape of the workpiece W is included in print data Img, or is input to the control device 600 from the external device 700 separately from the print data Img.

The imaging information db is information indicating the imaging result of the imaging device 330. The imaging information db indicates, for example, the brightness of each coordinate value of the camera coordinate system set in the imaging device 330. The camera coordinate system may or may not be associated with the above-mentioned base coordinate system by calibration in advance.

The point data Dc is information indicating a position where the liquid discharge head 310 should pass. The point data Dc indicates, for example, the scanning path of the liquid discharge head 310 with respect to the workpiece W or the object O with the coordinate values of the base coordinate system. The point data Dc is generated by the data generation section 614 described later.

The power supply circuit 630 receives a power from a commercial power supply (not illustrated) and generates various predetermined potentials. The generated various potentials are appropriately supplied to each portion of the three-dimensional object printing apparatus 100. For example, the power supply circuit 630 generates a power supply potential VHV and an offset potential VBS. The offset potential VBS is supplied to the liquid discharge head unit 300. The power supply potential VHV is supplied to the drive signal generation circuit 640.

The drive signal generation circuit 640 is a circuit that generates a drive signal Com for driving each piezoelectric element 311 included in the liquid discharge head 310. Specifically, the drive signal generation circuit 640 has, for example, a DA conversion circuit and an amplifier circuit. In the drive signal generation circuit 640, the DA conversion circuit converts a waveform designation signal dCom to be described later from the processing circuit 610 from a digital signal to an analog signal, and the amplifier circuit amplifies the analog signal by using the power supply potential VHV from the power supply circuit 630 and generates the drive signal Com. Here, among waveforms included in the drive signal Com, a signal of the waveform actually supplied to the piezoelectric element 311 is a drive pulse PD. The drive pulse PD is supplied from the drive signal generation circuit 640 to the piezoelectric element 311 via the drive circuit 340 for driving the piezoelectric element 311. The drive circuit 340 switches whether to supply, as the drive pulse PD, at least a part of the waveforms included in the drive signal Com based on a control signal SI to be described later.

In the above control device 600, the processing circuit 610 controls an operation of each portion of the three-dimensional object printing apparatus 100 by executing the program PG1 stored in the storage circuit 620. Specifically, the processing circuit 610 functions as an information acquisition section 611, the arm controller 612, a discharge controller 613, the data generation section 614, and a detection section 615 by executing the program PG1.

The information acquisition section 611 acquires various information necessary for driving the robot 200 and the liquid discharge head unit 300. Specifically, the information acquisition section 611 acquires information such as the print data Img from the external device 700, information D1 from the encoder included in the arm drive mechanism 230, the imaging information db from the imaging device 330, and the workpiece information Da and the point data Dc from the storage circuit 620. The information acquisition section 611 appropriately stores various acquired information in the storage circuit 620.

The arm controller 612 controls the driving of the robot 200 based on the information from the information acquisition section 611. Specifically, the arm controller 612 generates a control signal Sk based on the information D1, the workpiece information Da, and the point data Dc. The control signal Sk controls the driving of the motor included in the arm drive mechanism 230 such that the liquid discharge head 310 is in a desired position and a desired pose.

A correspondence between the information D1 and the position and the pose of the liquid discharge head is acquired in advance by calibration or the like, and is stored in the storage circuit 620. The arm controller 612 acquires information on the actual position and pose of the liquid discharge head 310 based on the information D1 from the actual arm drive mechanism 230 and the correspondence. Then, the arm controller 612 controls the liquid discharge head 310 to be in a desired position and pose by using the information on the position and the pose. The arm controller 612 may appropriately adjust the control signal Sk such that a distance between the liquid discharge head 310 and the surface of the workpiece W is maintained within a predetermined range by using the information from the displacement sensor not illustrated.

The discharge controller 613 controls the driving of the liquid discharge head unit 300 based on the information from the information acquisition section 611. Specifically, the discharge controller 613 generates the control signal SI and the waveform designation signal dCom based on the print data Img. The control signal SI is a digital signal for designating an operating state of the piezoelectric element 311 to be described later which is included in the liquid discharge head 310. Here, the control signal SI may include other signals such as a timing signal for defining a drive timing of the piezoelectric element 311. The timing signal is generated, for example, based on the information D1 from the encoder included in the arm drive mechanism 230. The waveform designation signal dCom is a digital signal for defining a waveform of the drive signal Com. The print data Img is information indicating a two-dimensional or three-dimensional image, and is supplied from the external device 700 such as a personal computer.

The drive control of the liquid discharge head 310 by the discharge controller 613 as described above is performed in synchronization with the drive control of the robot 200 by the arm controller 612 described above. Here, while the robot 200 causes the liquid discharge head 310 to scan the surface WF in a predetermined direction, the liquid discharge head 310 discharges ink so that an image in ink is printed on the surface WF of the workpiece W.

The data generation section 614 generates the point data Dc. As will be described in detail later, the data generation section 614 generates the workpiece information Da, generates the point data Dc indicating an ideal scanning path based on the workpiece information Da, and then corrects the point data Dc indicating the ideal scanning path based on the detection result of the detection section 615. The ideal scanning path corresponds to, for example, reference paths RU_1 and RU_2 described later. Here, in the generation of the workpiece information Da, as described above, the workpiece W is recognized by using a sensor or a camera (not illustrated) calibrated in the above-mentioned base coordinate system, and the information indicating the three-dimensional shape of the workpiece W is associated with the above-mentioned base coordinate system.

The detection section 615 detects the position of the liquid discharge head 310 relative to the workpiece W or the object O. This detection is performed by the detection operation MD described later, which detects the actual scanning path of the liquid discharge head 310, prior to a printing operation MP described later, which prints an image based on the print data Img. As will be described in detail later, the detection section 615 of the present embodiment detects the position of the liquid discharge head 310 on the actual scanning path with respect to the workpiece W or the object O by using the imaging result of the imaging device 330. Here, in the detection operation MD of the present embodiment, a detection pattern is printed on the workpiece W or the object O while the robot 200 is driven by using the point data Dc indicating the above-mentioned ideal scanning path, and then the detection pattern is imaged by the imaging device 330, and the position on the scanning path is detected by using the imaging result.

The image based on the print data Img is formed by N (N is a natural number of 1 or more) times of printing operation MP indicating the number of passes. The detection operation MD is performed N times corresponding to the number of times of the printing operation MP. In the following, the printing operation MP of an Nth pass is described as “printing operation MP_N”, and the detection operation MD of the Nth pass is described as “printing operation MD_N”. Here, the printing operation MP of a first pass is a first printing operation MP_1. The printing operation MP of a second pass is a second printing operation MP_2. The detection operation MD of the first pass is a first detection operation MD_1. The detection operation MD of a second pass is a second detection operation MD_2. In the following, the point data Dc used in the Nth pass may be referred to as point data Dc_N.

### 1-3. Liquid Discharge Head Unit

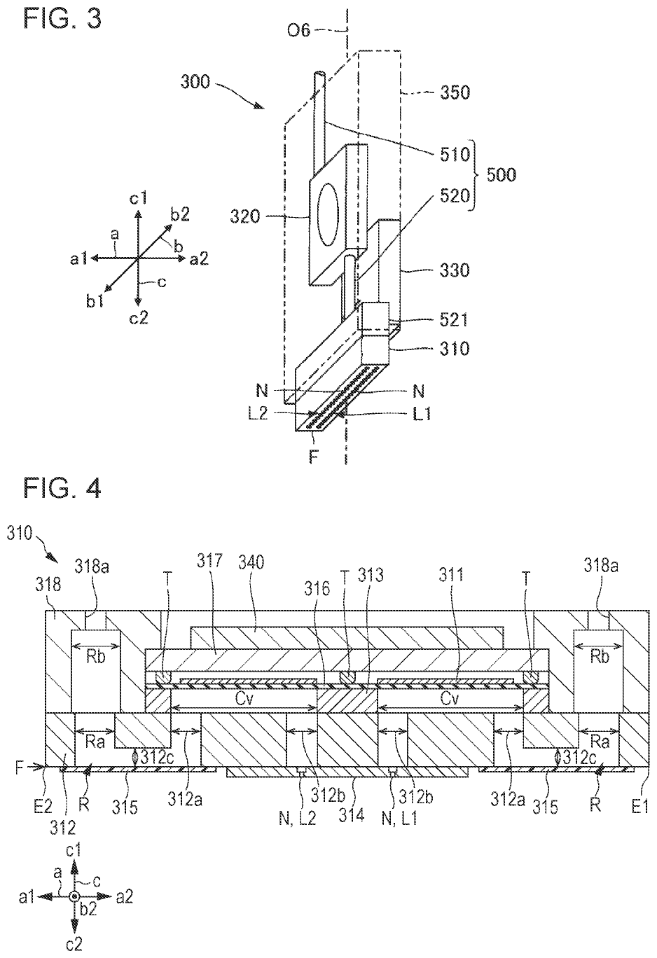

FIG. 3 is a perspective view illustrating a schematic configuration of the liquid discharge head unit 300 according to the embodiment.

The following description will be performed by using an a-axis, a b-axis, and a c-axis that intersect each other as appropriate. One direction along the a-axis is referred to as an a1 direction, and a direction opposite to the a1 direction is referred to as an a2 direction. Similarly, directions opposite to each other along the b-axis are referred to as a b1 direction and a b2 direction. Directions opposite to each other along the c-axis are referred to as a c1 direction and a c2 direction.

Here, the a-axis, the b-axis, and the c-axis are coordinate axes of a tool coordinate system set in the liquid discharge head unit 300, and a relationship between a position and a pose relative to the above-mentioned X-axis, Y-axis, and Z-axis changes by the operation of the above-mentioned robot 200. In the example illustrated in FIG. 3, the c-axis is an axis parallel to the above-mentioned sixth rotation axis O6. Although the a-axis, the b-axis, and the c-axis are typically orthogonal to each other, the present disclosure is not limited thereto, and the axes may intersect at an angle within, for example, a range of 80° or more and 100° or less.

As described above, the liquid discharge head unit 300 has the liquid discharge head 310, the pressure adjustment valve 320, and the imaging device 330. These portions are supported by a support 350 illustrated by a dashed double-dotted line in FIG. 3.

The support 350 is made of, for example, a metal material or the like, and is a substantially rigid body. In FIG. 3, the support 350 has a flat box shape, but a shape of the support 350 is not particularly limited and is any shape.

The above support 350 is attached to the tip of the arm 220, that is, the arm 226. Thus, each of the liquid discharge head 310, the pressure adjustment valve 320, and the imaging device 330 is fixed to the arm 226.

In the example illustrated in FIG. 3, the pressure adjustment valve 320 is positioned in the c1 direction with respect to the liquid discharge head 310. The imaging device 330 is positioned in the a2 direction with respect to the liquid discharge head 310.

In the example illustrated in FIG. 3, a part of the downstream flow path 520 of the supply flow path 500 is formed by the flow path member 521. The flow path member 521 has a flow path for distributing the ink from the pressure adjustment valve 320 to a plurality of locations of the liquid discharge head 310. The flow path member 521 is, for example, a stacked body of a plurality of substrates made of a resin material, and a groove or a hole for a flow path of the ink is appropriately provided in each substrate.

The liquid discharge head 310 has a nozzle surface F and a plurality of nozzles N opened to the nozzle surface F. In the example illustrated in FIG. 3, a normal direction of the nozzle surface F is the c2 direction, and the plurality of nozzles N are divided into a first nozzle array L1 and a second nozzle array L2 arranged at intervals in a direction along the a-axis. Each of the first nozzle array L1 and the second nozzle array L2 is a set of the plurality of nozzles N linearly arrayed in a direction along the b-axis. Here, in the liquid discharge head 310, elements related to each nozzle N of the first nozzle array L1 and elements related to each nozzle N of the second nozzle array L2 are substantially symmetrical with each other in a direction along the a-axis.

However, positions of the plurality of nozzles N in the first nozzle array L1 and the plurality of nozzles N in the second nozzle array L2 in the direction along the b-axis may or may not coincide with each other. The elements related to each nozzle N of one of the first nozzle array L1 and the second nozzle array L2 may be omitted. Hereinafter, a configuration in which the positions of the plurality of nozzles N in the first nozzle array L1 and the plurality of nozzles N in the second nozzle array L2 in the direction along the b-axis coincide with each other is exemplified.

FIG. 4 is a sectional view illustrating a configuration example of the liquid discharge head 310 according to the embodiment. As illustrated in FIG. 4, the liquid discharge head 310 includes a flow path substrate 312, a pressure chamber substrate 313, a nozzle plate 314, a vibration absorber 315, a vibration plate 316, a plurality of piezoelectric elements 311, a wiring substrate 317, and a housing 318.

The flow path substrate 312 and the pressure chamber substrate 313 form a flow path for supplying the ink to the plurality of nozzles N. The flow path substrate 312 and the pressure chamber substrate 313 are stacked in this order in the c1 direction. Each of the flow path substrate 312 and the pressure chamber substrate 313 is a plate-shaped member elongated in the direction along the b-axis. The flow path substrate 312 and the pressure chamber substrate 313 are joined to each other by, for example, an adhesive.

The vibration plate 316, the wiring substrate 317, the housing 318, and the drive circuit 340 are installed in a region positioned in the c1 direction with respect to the pressure chamber substrate 313. On the other hand, the nozzle plate 314 and the vibration absorber 315 are installed in a region positioned in the c2 direction with respect to the flow path substrate 312. These elements are generally plate-shaped members elongated in the direction along the b-axis like the flow path substrate 312 and the pressure chamber substrate 313, and are joined to each other by, for example, an adhesive.

The nozzle plate 314 is a plate-shaped member in which the plurality of nozzles N are formed. Each of the plurality of nozzles N is a circular through-hole through which the ink passes. For example, the nozzle plate 314 is manufactured by processing a silicon single crystal substrate by a semiconductor manufacturing technology using a processing technology such as dry etching or wet etching. However, other known methods and materials may be appropriately used for manufacturing the nozzle plate 314.

Here, the above-described nozzle surface F is a surface that expands from an opening of one end of the nozzle N in the c2 direction along a direction perpendicular to the c-axis among surfaces constituting an outer shape of the liquid discharge head 310. In the example illustrated in FIG. 4, a surface of the liquid discharge head 310 facing the c2 direction is the nozzle surface F, and the nozzle surface F includes a surface of the nozzle plate 314 facing the c2 direction.

A space Ra, a plurality of supply flow paths 312a, a plurality of communication flow paths 312b, and a supply liquid chamber 312c are provided in the flow path substrate 312 for each of the first nozzle array L1 and the second nozzle array L2. The space Ra is a long opening extending in the direction along the b-axis in plan view in a direction along the c-axis. Each of the supply flow paths 312a and the communication flow paths 312b is a through-hole formed for each nozzle N. The supply liquid chamber 312c is a long space extending in the direction along the b-axis over the plurality of nozzles N, and allows the space Ra and the plurality of supply flow paths 312a to be communicatively coupled to each other. Each of the plurality of communication flow paths 312b overlaps with one nozzle N corresponding to the communication flow path 312b in plan view.

The pressure chamber substrate 313 is a plate-shaped member in which a plurality of pressure chambers Cv called cavities are formed for each of the first nozzle array L1 and the second nozzle array L2. The plurality of pressure chambers Cv are arrayed in the direction along the b-axis. Each pressure chamber Cv is a long space formed for each nozzle N and extending in the direction along the a-axis in plan view. Each of the flow path substrate 312 and the pressure chamber substrate 313 is manufactured by processing a silicon single crystal substrate by, for example, a semiconductor manufacturing technology in the same manner as the nozzle plate 314 described above. However, other known methods and materials may be appropriately used for manufacturing the flow path substrate 312 and the pressure chamber substrate 313.

The pressure chamber Cv is a space positioned between the flow path substrate 312 and the vibration plate 316. The plurality of pressure chambers Cv are arrayed in the direction along the b-axis for each of the first nozzle array L1 and the second nozzle array L2. The pressure chamber Cv is communicatively coupled to each of the communication flow paths 312b and the supply flow paths 312a. Accordingly, the pressure chamber Cv is communicatively coupled to the nozzle N via the communication flow path 312b and is communicatively coupled to the space Ra via the supply flow path 312a and the supply liquid chamber 312c.

The vibration plate 316 is disposed on a surface of the pressure chamber substrate 313 facing the c2 direction. The vibration plate 316 is a plate-shaped member that can vibrate elastically. The vibration plate 316 has, for example, an elastic film made of silicon oxide (SiO₂) and an insulating film made of zirconium oxide (ZrO₂), and these films are stacked. The elastic film is formed, for example, by thermally oxidizing one surface of a silicon single crystal substrate. The insulating film is formed by, for example, forming a zirconium layer by a sputtering method and thermally oxidizing the layer.

The plurality of piezoelectric elements 311 respectively corresponding to each nozzle N are arranged on a surface of the vibration plate 316 facing the c1 direction for each of the first nozzle array L1 and the second nozzle array L2. Each piezoelectric element 311 is a passive element deformed by the supply of the above-described drive pulse PD. Each piezoelectric element 311 has a long shape extending in the direction along the a-axis in plan view. The plurality of piezoelectric elements 311 are arrayed in the direction along the b-axis so as to correspond to the plurality of pressure chambers Cv. When the vibration plate 316 vibrates in conjunction with the deformation of the piezoelectric element 311, the pressure in the pressure chamber Cv fluctuates, and thus, the ink is discharged from the nozzle N in the c2 direction.

The housing 318 is a case for reserving the ink to be supplied to the plurality of pressure chambers Cv. As illustrated in FIG. 4, a space Rb is formed in the housing 318 of the present embodiment for each of the first nozzle array L1 and the second nozzle array L2. The space Rb of the housing 318 and the space Ra of the flow path substrate 312 are communicatively coupled to each other. A space formed of the space Ra and the space Rb functions as a liquid storage chamber R which is a reservoir for reserving the ink supplied to the plurality of pressure chambers Cv. The Ink is supplied to the liquid storage chamber R via an introduction port 318a formed in the housing 318. The ink in the liquid storage chamber R is supplied to the pressure chamber Cv via the supply liquid chamber 312c and each supply flow path 312a. The vibration absorber 315 is a flexible film-like compliance substrate constituting the wall surface of the liquid storage chamber R, and absorbs a pressure fluctuation in the ink in the liquid storage chamber R.

The wiring substrate 317 is a plate-shaped member in which wirings for electrically coupling the drive circuit 340 and the plurality of piezoelectric elements 311 are formed. A surface of the wiring substrate 317 facing the c2 direction is joined to the vibration plate 316 via a plurality of conductive bumps T. On the other hand, the drive circuit 340 is mounted on a surface of the wiring substrate 317 facing the c1 direction.

The drive circuit 340 is an integrated circuit (IC) chip that outputs a drive signal and a reference voltage for driving each piezoelectric element 311. Specifically, the drive circuit 340 switches whether or not to supply, as the drive pulse PD, the drive signal Com for each of the plurality of piezoelectric elements 311 based on the above-mentioned control signal SI.

Although not illustrated, an end portion of an external wiring electrically coupled to the control device 600 is joined to the surface of the wiring substrate 317 facing the c1 direction. The external wiring includes, for example, coupling components such as flexible printed circuits (FPC) or flexible flat cable (FFC). The wiring substrate 317 may be the FPC, the FFC, or the like.

### 1-4. Operation of Three-Dimensional Object Printing Apparatus and Three-Dimensional Object Printing Method

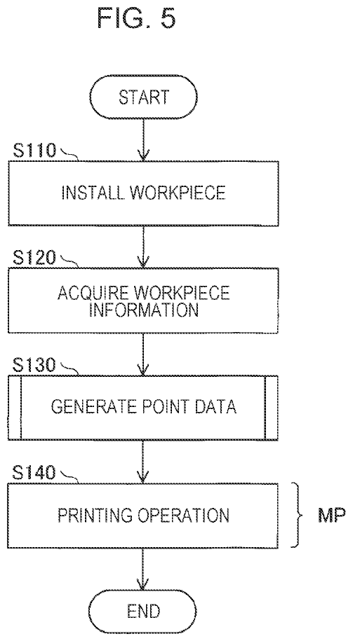

FIG. 5 is a flowchart illustrating the flow of a three-dimensional object printing method according to the first embodiment. The three-dimensional object printing method is performed by using the three-dimensional object printing apparatus 100. In the three-dimensional object printing apparatus 100, as illustrated in FIG. 5, the workpiece W is first installed in step S110. At this time, if necessary, the object O is installed in place of the workpiece W or in addition to the workpiece W. The workpiece or the object O may be installed manually by a user, or may be automatically installed by the operation of the robot 200 according to the program PG1.

Next, in step S120, the workpiece information Da is generated by the data generation section 614 using the CAD data of the workpiece W as described above. Then, in step S130, the point data Dc is generated by the data generation section 614. At this time, the detection operation MD is performed N times according to the number of passes. Then, in step S140, the printing operation MP is performed N times according to the number of passes by using the point data Dc generated in step S130.

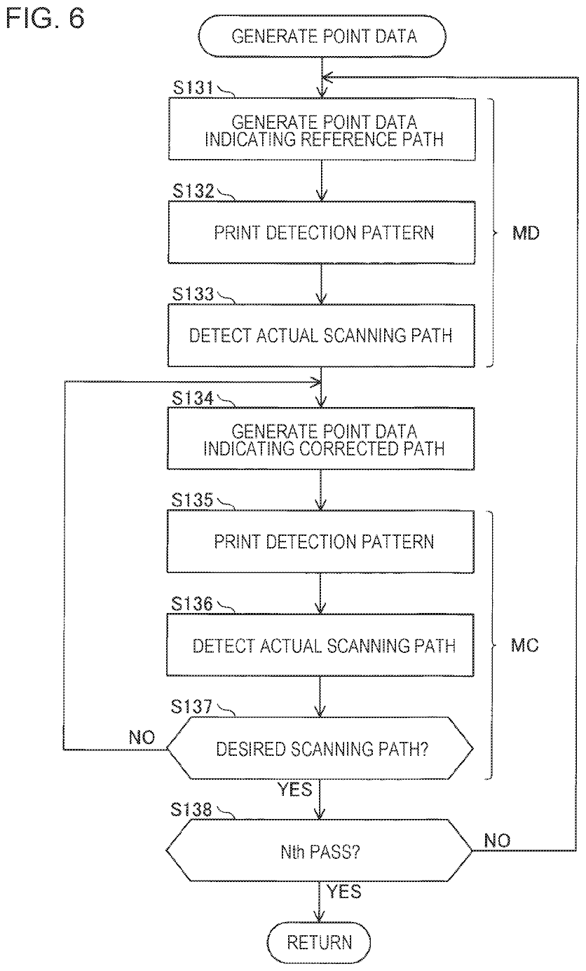

FIG. 6 is a flowchart illustrating the flow of generation of the point data Dc illustrated in FIG. 5. Hereinafter, the flow of processing in step S130 illustrated in FIG. 5 will be described based on FIG. 6. As illustrated in FIG. 6, first, the detection operation MD for detecting the actual scanning path of the liquid discharge head 310 is performed.

In the detection operation MD, first, in step S131, the data generation section 614 generates point data Dc indicating the ideal scanning path as a reference path based on the workpiece information Da. Next, in step S132, the detection pattern is printed on the workpiece W or the object O while the robot 200 is operated by using the point data Dc generated in step S131. Then, in step S133, the actual scanning path in step S132 is detected.

Next, in step S134, the data generation section 614 generates the point data Dc indicating a corrected path based on the detection result of the detection operation MD, that is, the actual scanning path detected in step S133. Then, a confirmation operation MC is performed.

In the confirmation operation MC, first, in step S135, the detection pattern is printed on the workpiece W or the object O in the same manner as in step S132, while the robot 200 is operated by using the point data Dc generated in step S134. Next, in step S136, the actual scanning path in step S135 is detected in the same manner as in step S133 described above. Then, in step S137, it is determined whether or not the actual scanning path detected in step S136 is a desired scanning path. For example, when the difference between the actual scanning path detected in step S136 and the reference path is within a predetermined range, it is determined that the actual scanning path detected in step S136 is the desired scanning path.

When the actual scanning path is not the desired scanning path, the process returns to step S134 described above, the point data Dc is adjusted so that the actual scanning path approaches the reference path, and the point data Dc indicating the corrected path is generated by the data generation section 614. On the other hand, when the actual scanning path is the desired scanning path, in step S138, it is determined whether or not the pass is the Nth pass depending on whether or not the number of transitions from step S137 is the Nth.

When the Nth pass has not been reached, the process returns to step S131 described above, and the same processing as described above is performed for the subsequent pass. On the other hand, when the Nth pass is reached, the process proceeds to step S140 illustrated in FIG. 5 described above, and printing is performed.

Although it is possible to confirm that the path is the desired path by the confirmation operation MC, the confirmation operation MC is not an essential operation in the present disclosure, and may be omitted as appropriate depending on the required degree of print quality and the like to shorten the time required for adjustment of the point data. In other words, after the point data Dc is generated in step S134, the process may proceed directly to step S138.

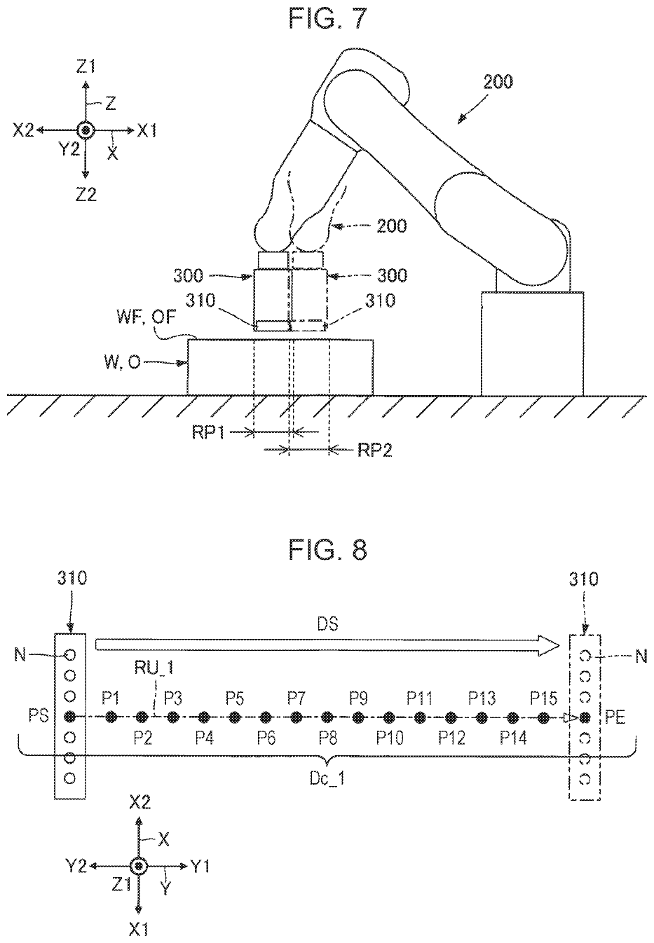

FIG. 7 is a diagram illustrating the detection operation MD and the printing operation MP in the first embodiment. FIG. 7 illustrates a case where the number of passes, which is the number of times that each of the detection operation MD and the printing operation MP is performed, is two. In the example illustrated in FIG. 7, in each operation, the liquid discharge head 310 is scanned in the direction along the Y-axis.

Printing by the printing operation MP_1 of the first pass is performed on a first region RP1 of the workpiece W, but prior to this printing, the detection operation MD_1 of the first pass is performed on the first region RP1 or the region corresponding to the first region RP1. Similarly, printing by the printing operation MP_2 of the second pass is performed on a second region RP2 of the workpiece W, but prior to this printing, the detection operation MD_2 of the second pass is performed on the second region RP2 or the region corresponding to the second region RP2. Here, the first region RP1 and the second region RP2 are disposed so as to deviate in the direction along the X-axis so that parts of the first region RP1 and the second region RP2 overlap each other. In the present embodiment, after the first pass and second pass detection operation MDs are sequentially performed, the first pass and second pass printing operation MPs are sequentially performed. The number of passes may be one or three or more.

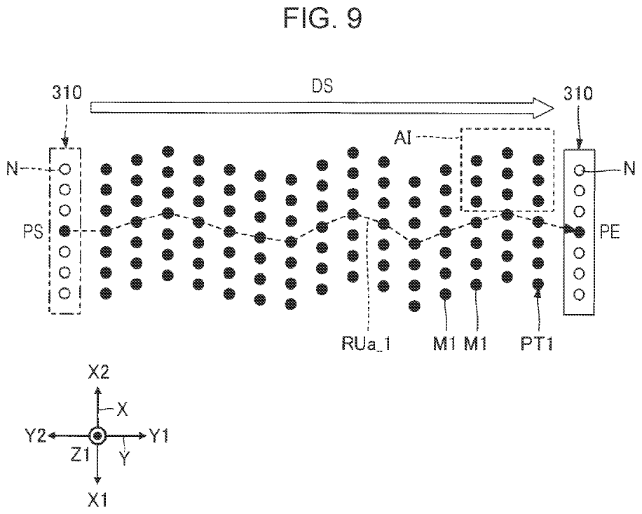

FIG. 8 is a diagram illustrating point data Dc illustrating the ideal scanning path. In FIG. 8, point data Dc_1 indicating the reference path RU_1, which is the ideal scanning path in the detection operation MD of the first pass, is illustrated. FIG. 8 schematically illustrates the plurality of nozzles N of the liquid discharge head 310. In FIG. 8, the ideal scanning path is a linear path along a scanning direction DS of the liquid discharge head 310, but the ideal scanning path may have curved or bent portions, if necessary.

In the example illustrated in FIG. 8, the point data Dc_1 is composed of 17 pieces of data including data PS, P1 to P15, and PE. The data PS indicates the start position of the liquid discharge head 310 in the scanning path. The data PE indicates the end position of the liquid discharge head 310 in the scanning path. The data P1 to P15 indicate positions between the start position and the end position of the liquid discharge head 310 in the scanning path. The number of pieces of data indicating the position between the start position and the end position of the liquid discharge head 310 in the scanning path is not limited to the example illustrated in FIG. 8, and is freely selected.

FIG. 9 is a diagram illustrating the detection of the position of an actual scanning path RUa when the point data Dc_1 indicating the ideal scanning path is used. In FIG. 9, a first scanning path RUa_1, which is the actual scanning path RUa in the detection operation MD of the first pass, is illustrated. In the detection operation MD of the first pass, as illustrated in FIG. 9, a first detection pattern PT1 is printed as a detection pattern.

In the example illustrated in FIG. 9, the first detection pattern PT1 is composed of a plurality of marks M1. The plurality of marks M1 are formed by discharging ink from each nozzle N at each position indicated by the above-mentioned point data Dc_1. When the first scanning path RUa_1 is an ideal scanning path, the plurality of marks M1 of the first detection pattern PT1 are arranged in a matrix in the X-axis direction and the Y-axis direction. In FIG. 9, the first scanning path RUa_1 deviates and meanders from the ideal scanning path in the X-axis direction, and the arrangement of the plurality of marks M1 in the first detection pattern PT1 is distorted in the X-axis direction.

The detection of the first scanning path RUa_1 is performed by using the imaging information db obtained by imaging the first detection pattern PT1 with the imaging device 330. The imaging is performed, for example, while the imaging device 330 is scanning together with the liquid discharge head 310 when the first detection pattern PT1 is formed. The imaging may be performed by the imaging device 330 in a separate scan after the formation of the first detection pattern PT1.

In FIG. 9, the angle of view AI of the imaging device 330 is illustrated with a broken line. The angle of view AI preferably includes two or more marks M1. When the angle of view AI includes two or more marks M1 having different positions in the direction along the Y-axis, based on the positional relationship of these marks M1, it is possible to detect a deviation of the actual position corresponding to adjacent two pieces of data among a plurality of pieces of data indicated by the point data Dc_1 in the direction along the X-axis and a deviation in the direction along the Y-axis. When the angle of view AI includes two or more marks M1 having different positions in the direction along the X-axis, it is also possible to detect the pose around the Y-axis from the interval between the marks M1. When the angle of view AI includes two or more marks M1 having different positions in the direction along the Y-axis and two or more marks M1 having different positions in the direction along the X-axis, it is also possible to detect the pose of the liquid discharge head 310 around the Z-axis based on the positional relationship of these marks M1.

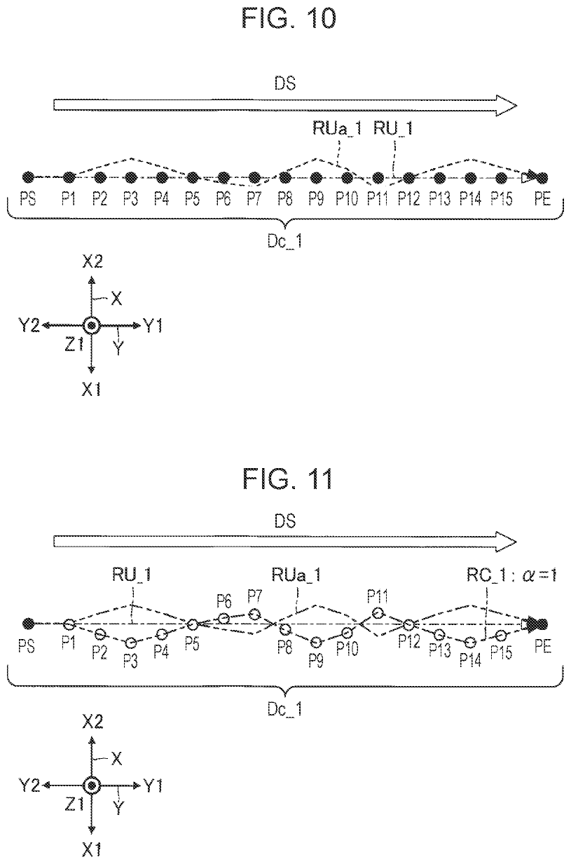

FIG. 10 is a diagram illustrating a deviation of the actual scanning path RUa with respect to the ideal scanning path. In FIG. 10, the first scanning path RUa_1, which is the actual scanning path in the detection operation MD of the first pass, is illustrated in comparison with the reference path RU_1.

FIG. 11 is a diagram illustrating an example of the point data Dc_1 corrected based on the actual scanning path RUa. In FIG. 11, the point data Dc_1 corrected by using the detection result of the detection operation MD of the first pass is illustrated. As illustrated in FIG. 11, the point data Dc_1 generated in the above-mentioned step S134 is obtained by obtaining a corrected path RC_1 that moves so as to offset the deviation of the first scanning path RUa_1 with respect to the reference path RU_1 and correcting the point data Dc_1 so as to indicate the position of the corrected path RC_1.

In the example illustrated in FIG. 11, the absolute value of the difference between the reference path RU_1 and the corrected path RC_1 is equal to the absolute value of the difference between the reference path RU_1 and the first scanning path RUa_1. That is, when the absolute value of the difference between the reference path RU_1 and the corrected path RC_1 is the correction amount obtained by multiplying the absolute value of the difference between the reference path RU_1 and the first scanning path RUa_1 by a coefficient α, α is 1.

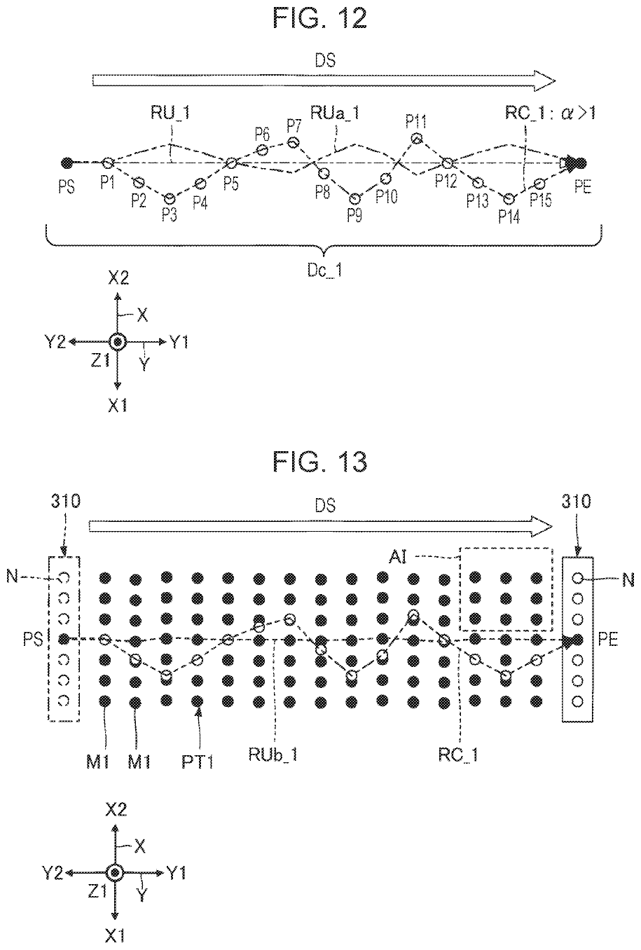

FIG. 12 is a diagram illustrating another example of the point data Dc_1 corrected based on the actual scanning path RUa. In the example illustrated in FIG. 12, the absolute value of the difference between the reference path RU_1 and the corrected path RC_1 is larger than the absolute value of the difference between the reference path RU_1 and the first scanning path RUa_1. That is, when the absolute value of the difference between the reference path RU_1 and the corrected path RC_1 is the correction amount obtained by multiplying the absolute value of the difference between the reference path RU_1 and the first scanning path RUa_1 by the coefficient α, α is larger than 1. That is, the degree of correction of the point data Dc_1 based on the actual scanning path RUa can be freely set by the coefficient α. Although FIG. 12 illustrates a case where a is larger than 1, it is also possible to set a smaller than 1.

FIG. 13 is a diagram illustrating an actual scanning path RUb when the corrected point data Dc_1 is used. FIG. 13 illustrates a state in which the first detection pattern PT1 is printed while the robot 200 is operated by using the point data Dc_1 corrected based on the detection result of the detection operation MD in the first pass in the confirmation operation MC. In FIG. 13, the corrected path RC_1 illustrated in FIG. 12 described above is illustrated for comparison with an actual scanning path. The actual scanning path corresponds to a second scanning path RUb_1, which is the actual scanning path in the first printing operation MP_1.

As illustrated in FIG. 13, the deviation of the second scanning path RUb_1 with respect to the ideal scanning path is reduced. The detection of the actual scanning path in the confirmation operation MC is performed in the same manner as the detection of the first scanning path RUa_1.

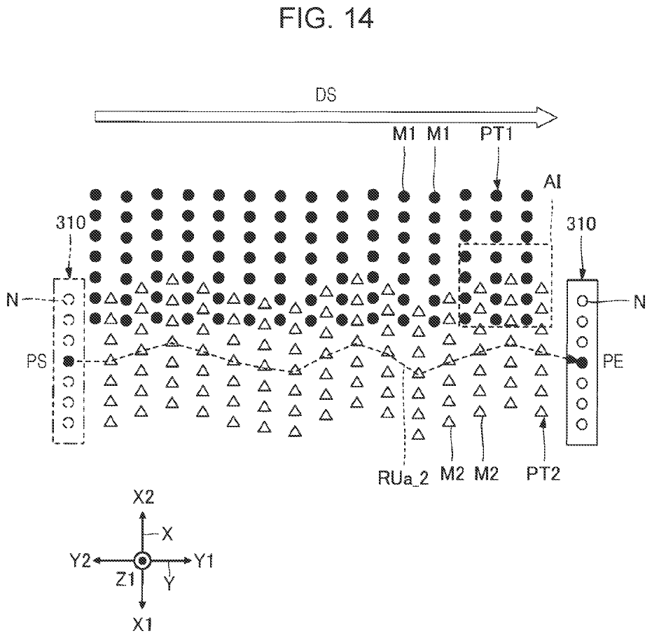

FIG. 14 is a diagram illustrating the detection of the actual scanning path RUa in the subsequent pass. FIG. 14 illustrates a state in which a second detection pattern PT2, which is the detection pattern in the detection operation MD of the second pass, is printed.

In the example illustrated in FIG. 14, the second detection pattern PT2 is composed of a plurality of marks M2. The plurality of marks M2 are formed by discharging ink from each nozzle N at each position indicated by the point data Dc of the second pass, similarly to the plurality of marks M1 of the first detection pattern PT1 described above. However, the second detection pattern PT2 is disposed at a position deviated from the first detection pattern PT1 in the direction along the Y-axis. Therefore, it is possible to detect the second detection pattern PT2 separately from the first detection pattern PT1 from the imaging result of the imaging device 330.

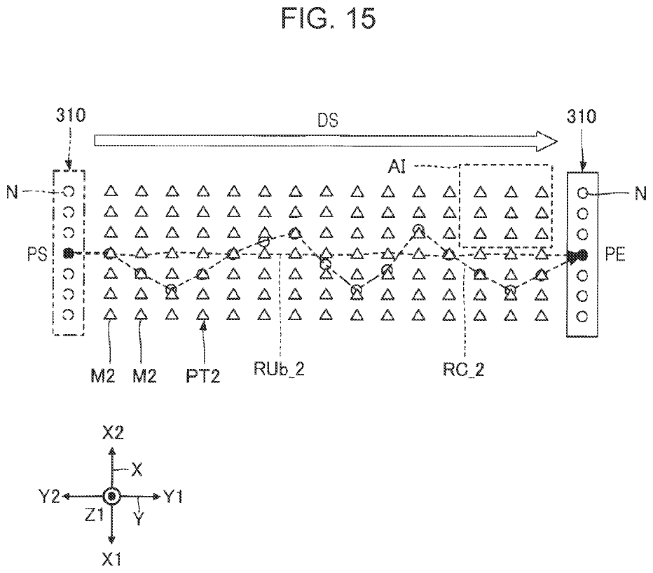

FIG. 15 is a diagram illustrating the corrected scanning path RUb in the subsequent pass. FIG. 15 illustrates a state in which the second detection pattern PT2 is printed while the robot 200 is operated by using the point data Dc corrected based on the detection result of the detection operation MD of the second pass in the confirmation operation MC. In FIG. 15, the corrected path RC_2, which is the path indicated by the point data Dc, is illustrated for comparison with the actual scanning path. The actual scanning path corresponds to the second scanning path RUb_1, which is the actual scanning path in the second printing operation MP_2.

As described above, the three-dimensional object printing apparatus 100 includes the liquid discharge head 310, the robot 200 which is an example of a “moving mechanism”, and the detection section 615. As described above, the liquid discharge head 310 discharges ink, which is an example of “liquid”, to the three-dimensional workpiece W. The robot 200 changes the position and pose of the liquid discharge head 310 relative to the workpiece W. The detection section 615 detects the position of the liquid discharge head 310 relative to the workpiece W or the object O. As described above, the three-dimensional object printing apparatus 100 of the present embodiment includes the imaging device 330, and the detection section 615 detects the position of the liquid discharge head 310 relative to the workpiece W or the object O based on the imaging result of the imaging device 330.

In particular, the three-dimensional object printing apparatus 100 executes the first detection operation MD_1 and the first printing operation MP_1 as described above. In the first detection operation MD_1, the detection section 615 detects the position of the first scanning path RUa_1 while the robot 200 causes the liquid discharge head 310 to scan the workpiece W or the object O along the first scanning path RUa_1. In the first printing operation MP_1, the liquid discharge head 310 discharges ink to the first region RP1 of the workpiece W while the robot 200 causes the liquid discharge head 310 to scan along the second scanning path RUb_1 based on the detection result by the detection section 615 in the first detection operation MD 1.

In the above three-dimensional object printing apparatus 100, since the second scanning path RUb_1 is based on the detection result by the detection section 615 in the first detection operation MD_1, the first printing operation MP_1 can be performed by using the second scanning path RUb_1 in which the deviation of the first scanning path RUa_1 with respect to the reference path RU_1 is corrected. Here, when the deviation amount of the first scanning path RUa_1 with respect to the reference path RU_1 is a first amount, the path difference between the first scanning path RUa_1 and the second scanning path RUb_1 is a first path difference, and when the deviation amount is a second amount larger than the first amount, the path difference is a second path difference larger than the first path difference. In other words, the larger the path difference between the first scanning path RUa_1 and the reference path RU_1, the larger the correction amount, and therefore the path difference between the first scanning path RUa_1 and the second scanning path RUb_1 also increases. Therefore, the image quality of printing on the first region RP1 of the workpiece W can be improved as compared with the case where the first printing operation MP_1 is performed without performing the first detection operation MD_1.

Since printing is performed by the first printing operation MP_1 after the first detection operation MD_1, the printing speed can be increased as compared with the configuration in which the scanning path is corrected by feedback control while detecting the deviation described above. On the other hand, in the configuration in which the feedback control is performed, since the printing speed is limited by the control cycle, it is difficult to increase the printing speed.

By grasping the deviation amount of the first scanning path RUa_1 with respect to the reference path RU_1, which is the ideal scanning path, from the detection result by the detection section 615 in the first detection operation MD_1, and correcting the print data Img so that the deviation amount is offset, or controlling the nozzle corresponding to the ink discharge to be shifted in the nozzle array direction so that the deviation amount is offset, it is also possible to improve the printing image quality for the first region RP1 of the workpiece W without correcting the point data Dc_1, but in this case, since it is necessary to set the valid printing width in the b-axis direction in one time of printing operation to be narrower than the length of the nozzle array, the printing productivity is lowered.

In the first detection operation MD_1, the liquid discharge head 310 discharges ink to the workpiece W or the object O to form the first detection pattern PT1, and the detection section 615 detects the position of the first scanning path RUa_1 by detecting the first detection pattern PT1.

Here, the first detection pattern PT1 indicates the actual landing position of the ink from the liquid discharge head 310 with respect to the workpiece W or the object O. Therefore, by using the first detection pattern PT1, the deviation of the first scanning path RUa_1 with respect to the reference path RU_1 can be detected with higher accuracy as compared with the case of detecting the position of the first scanning path RUa_1 without actually discharging ink.

The three-dimensional object printing apparatus 100 of the present embodiment includes the imaging device 330. The detection section 615 detects the position of the liquid discharge head 310 on the scanning path with respect to the workpiece W or the object O by using the imaging result of the imaging device 330.

Here, the first detection pattern PT1 of the present embodiment includes the plurality of marks M1 disposed at intervals from each other, and the imaging device 330 images the first detection pattern PT1 with an angle of view AI including two or more of the plurality of marks M1. Therefore, since one captured image includes the two or more marks M1, for example, compared with the case where only one mark M1 is included in one captured image, it is easy to detect the positional relationship between the plurality of marks M1 with high accuracy. Therefore, such detection has an advantage that the deviation of the first scanning path RUa_1 with respect to the reference path RU_1 can be easily detected with high accuracy. In particular, if the positional relationship between the plurality of marks M1 having different positions in the scanning direction DS is detected, printing defects due to the first printing operation MP_1, for example, distortion that occurs in the direction intersecting the scanning direction DS in the printed image, are unlikely to occur, and the image quality of printing by the first printing operation MP_1 is likely to be improved.

As described above, the position of the imaging device 330 with respect to the liquid discharge head 310 is fixed. Therefore, the formation and imaging of the first detection pattern PT1 can be performed collectively in one time of scanning. As a result, the time required for the first detection operation MD_1 can be shortened as compared with the case where the formation and imaging of the first detection pattern PT1 are performed by separate scanning. Since the angle of view AI of the imaging device 330 follows the movement of the liquid discharge head 310 accompanying the formation of the first detection pattern, even if the number of imaging devices 330 is one, the first detection pattern PT1 can be imaged by the imaging device 330 over the entire scanning direction DS. Therefore, the configuration of the three-dimensional object printing apparatus 100 can be simplified and the region for printing can be widened as compared with the configuration in which the position of the imaging device 330 is fixed with respect to the workpiece W or the object O. On the other hand, in the configuration in which the position of the imaging device 330 is fixed with respect to the workpiece W or the object O, depending on the installation position or the number of imaging devices 330, the region on which the first detection pattern PT1 can be formed or printed is limited according to the range in which the imaging device 330 can image.

The first detection pattern PT1 may be formed and imaged by separate scanning. In this case, the scanning speeds in the formation and imaging of the first detection pattern PT1 can be different from each other. Therefore, there is an advantage that it is easy to improve the accuracy of each of the formation and imaging of the first detection pattern PT1.

As described above, the three-dimensional object printing apparatus 100 further executes the second detection operation MD_2 and the second printing operation MP_2. In the second detection operation MD_2, while the robot 200 causes the liquid discharge head 310 to scan the workpiece W or the object O along a third scanning path RUa_2 between the first detection operation MD_1 and the first printing operation MP_1 described above, the detection section 615 detects the position of the third scanning path RUa_2. In the second printing operation MP_2, while the robot 200 causes the liquid discharge head 310 to scan the workpiece W or the object O along a fourth scanning path RUb_2 based on the detection result by the detection section 615, the liquid discharge head 310 discharges ink to the second region RP2 which partially overlaps the first region RP1 of the workpiece W.

Here, similarly to the relationship between the first scanning path RUa_1 and the second scanning path RUb_1 described above, when the deviation amount of the third scanning path RUa_2 with respect to the reference path RU_2 is a third amount, the path difference between the third scanning path RUa_2 and the fourth scanning path RUb_2 is a third path difference, and when the deviation amount is a fourth amount larger than the third amount, the path difference is a fourth path difference larger than the third path difference. Therefore, as in the case of printing on the first region RP1 described above, the image quality of printing on the second region RP2 of the workpiece W can be improved as compared with the case where the second printing operation MP_2 is performed without performing the second detection operation MD_2. The execution timing of the second printing operation MP_2 may be before or after the first printing operation MP_1 as long as the execution timing is after the second detection operation MD_2.

Similarly to the first detection pattern PT1 in the first detection operation MD_1 described above, in the second detection operation MD_2, the liquid discharge head 310 discharges ink to the workpiece W or the object O to form the second detection pattern PT2 at a position deviated from the first detection pattern PT1 in the scanning direction DS of the liquid discharge head 310, and the detection section 615 detects the position of the third scanning path RUa_2 by detecting the second detection pattern PT2. Therefore, as in the case where the first detection pattern PT1 is used, by using the second detection pattern PT2, the deviation of the third scanning path RUa_2 with respect to the reference path RU_2 can be detected with higher accuracy as compared with the case of detecting the position of the third scanning path RUa_2 without actually discharging the ink.

Here, the second detection pattern PT2 is not only formed in a region different from that of the first detection pattern PT1, but also formed at a position deviated from the first detection pattern PT1 in the scanning direction DS of the liquid discharge head 310. Therefore, it is easy to distinguish and detect the second detection pattern PT2 from the first detection pattern PT1. It is also easy to detect the positional relationship between the first detection pattern PT1 and the second detection pattern PT2.

In the present embodiment, as described above, the shapes or colors of the first detection pattern PT1 and the second detection pattern PT2 are different from each other. Therefore, it is easier to distinguish and detect the second detection pattern PT2 from the first detection pattern PT1 as compared with the case where the shapes and colors of these patterns are the same.

The amount of ink used for forming the first detection pattern PT1 composed of the plurality of marks M1 as described above is smaller than the amount of ink used for the first printing operation MP_1. Therefore, compared with the case where the amount of ink used for forming the first detection pattern PT1 is larger than the amount of ink used for the first printing operation MP_1, the influence of the first detection pattern PT1 on the image quality of printing in the first printing operation MP_1 is reduced. The same applies to the second detection pattern PT2 as the first detection pattern PT1, and the influence of the second detection pattern PT2 on the image quality of printing in the second printing operation MP_2 is reduced.

As described above, the three-dimensional object printing apparatus 100 further executes the confirmation operation MC between the first detection operation MD_1 and the first printing operation MP_1. In the confirmation operation MC, while the robot 200 causes the liquid discharge head 310 to scan the workpiece W or the object O along the scanning path based on the detection result by the detection section 615 in the first detection operation MD_1, the detection section 615 detects the position on the scanning path. Therefore, after confirming that the second scanning path RUb_1 is a desired path based on the detection result of the detection section 615 in the confirmation operation MC, the first printing operation MP_1 can be executed by using the second scanning path RUb_1.

As described above, the robot 200 is coupled to the control device 600, which is an example of a “robot controller”, and is an articulated robot to which the liquid discharge head unit 300, which is an example of an end effector including the liquid discharge head 310, is attached. The robot 200 moves the liquid discharge head unit 300 along a linear path such as a straight line or a curved line by combining the operations of a plurality of the joint portions 231 to 236. At this time, even if the reference path RU_1, which is an ideal path, is given to the robot 200 as an instruction of the path along which the liquid discharge head 310 should move, since the operation error of each joint portion appears at various timings due to various errors such as a processing error or an assembly error of each arm, mechanical vibration of each arm, eccentricity of the motor or the speed reducer, roughness of disassembly of the rotary encoder, and the like, the actual path meanders and deviates from the ideal path. It is difficult to predict such a deviation in advance. Therefore, when such an articulated robot is used as a moving mechanism, the effect of executing the first detection operation MD_1 and the first printing operation MP_1 becomes remarkable. The above-mentioned deviation of the actual path with respect to the ideal scanning path can also occur in a moving mechanism other than the articulated robot, that is, a mechanism capable of moving by combining the operations of a plurality of movable portions, and executing the first detection operation MD_1 and the first printing operation MP_1 is equally useful in moving the liquid discharge head 310 along an ideal scanning path.

As described above, the three-dimensional object printing apparatus 100 further includes the data generation section 614 that generates the point data Dc indicating a position where the liquid discharge head 310 should pass. The control device 600 controls the drive of the robot 200 based on the point data Dc from the data generation section 614. Here, the data generation section 614 generates the point data Dc_1 used for the first printing operation MP_1 based on the detection result of the detection section 615 in the first detection operation MD_1.

Specifically, the data generation section 614 generates the point data Dc_1 to be used for the first printing operation MP_1 by correcting the point data Dc_1 used in the first detection operation MD_1 based on the detection result of the detection section 615 in the first detection operation MD_1 so that the second scanning path RUb_1 is closer to the reference path RU_1 than the first scanning path RUa_1.

Here, based on the detection result of the detection section 615 in the first detection operation MD_1, the data generation section 614 corrects the point data Dc_1 used in the first detection operation MD_1 so that the position where the liquid discharge head 310 should pass is shifted in the direction intersecting a first scanning path Pia. Therefore, the second scanning path RUb_1 can be brought closer to the reference path RU_1 than a first scanning path RUa_1b.

As described above, in the first detection operation MD_1, either the workpiece W or the object O corresponding to the workpiece W is used. In the first detection operation MD_1, when the robot 200 causes the liquid discharge head 310 to scan the object O and the detection section 615 to detect the object O, the shape of the object O is substantially the same as the shape of the workpiece W, and the object O is replaced with the workpiece W between the first detection operation MD_1 and the first printing operation MP_1. Therefore, the ink discharged in the first detection operation MD_1 does not affect the image quality of printing with respect to the workpiece W in the first printing operation MP_1.

On the other hand, in the first detection operation MD_1, when the robot 200 causes the liquid discharge head 310 to scan the workpiece W and the detection section 615 to detect the workpiece W, there is an advantage that there is no need to replace the object O with the workpiece W as described above.

### 2. Second Embodiment

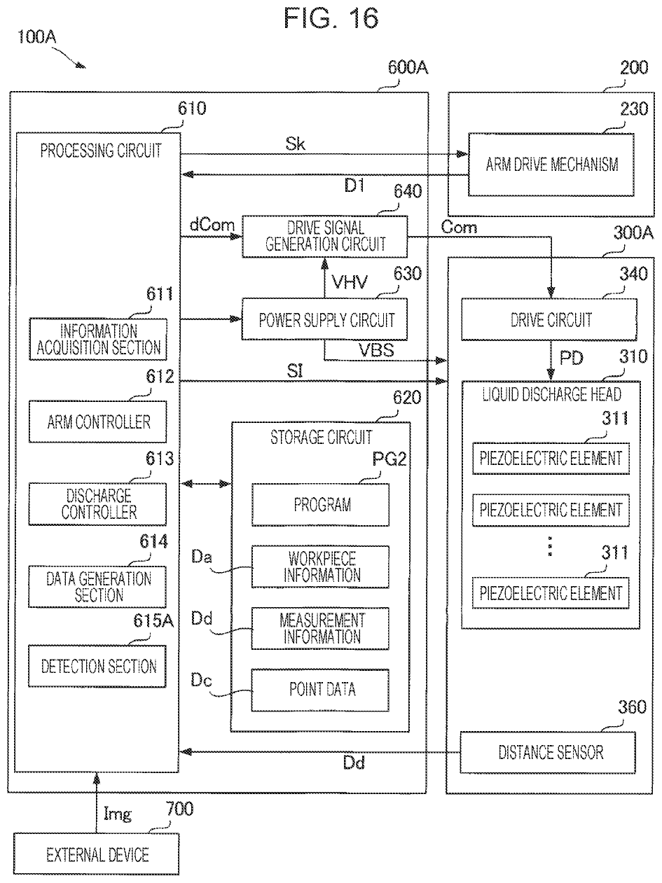

FIG. 16 is a block diagram illustrating an electrical configuration of a three-dimensional object printing apparatus 100A according to a second embodiment. The three-dimensional object printing apparatus 100A is the same as the three-dimensional object printing apparatus 100 of the first embodiment described above, except that a liquid discharge head unit 300A and a control device 600A are provided in place of the liquid discharge head unit 300 and the control device 600. The liquid discharge head unit 300A is the same as the liquid discharge head unit 300 except that a distance sensor 360 is provided in place of the imaging device 330. The control device 600A is the same as the control device 600 except that a program PG2 is used in place of the program PG1.

In the control device 600A, the processing circuit 610 functions as an information acquisition section 611, an arm controller 612, a discharge controller 613, a data generation section 614, and a detection section 615A by executing the program PG2 stored in the storage circuit 620.

The detection section 615A detects the position of the liquid discharge head 310 on the scanning path with respect to the workpiece W or the object O by using measurement information Dd which is the measurement result of the distance sensor 360.

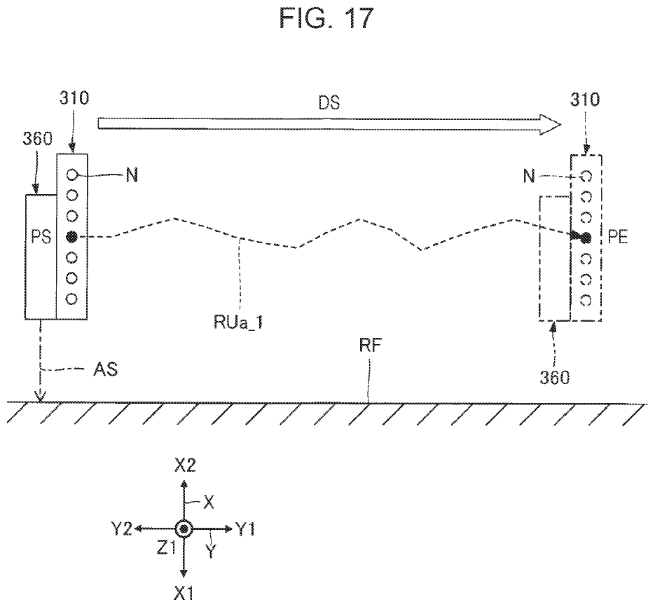

FIG. 17 is a diagram illustrating the detection of the actual scanning path RUa in the second embodiment. As illustrated in FIG. 17, the distance sensor 360 is a displacement sensor that measures the distance from a reference plane RF of which a position relative to the workpiece W is fixed. An example is that the reference plane RF of the present embodiment is a plane facing the X2 direction. Here, a detection axis AS of the distance sensor 360 intersects the reference plane RF. In the example illustrated in FIG. 17, the detection axis AS faces the X1 direction. The reference plane RF may be the surface of any object as long as the position relative to the workpiece W is fixed, may be the surface of the workpiece W, or may be the surface of an object such as a plate material that is separate from the workpiece W. The direction in which the reference plane RF faces is not limited to the X2 direction as long as the position and pose of the workpiece W with respect to the surface WF are known in advance, and is freely selected.

The flow of the three-dimensional object printing method using the three-dimensional object printing apparatus 100A will be described. The three-dimensional object printing method follows the description of the flowcharts of FIGS. 5 and 6 as a basic order, but unlike the first embodiment, printing of the detection pattern in steps S132 and S135 is not executed in the present embodiment.

In the three-dimensional object printing method, the workpiece W is first installed as in the first embodiment. At this time, if necessary, the object O is installed in place of the workpiece W or in addition to the workpiece W. The workpiece or the object O may be installed manually by the user, or may be automatically installed by the operation of the robot 200 according to the program PG2.

Next, the workpiece information Da is generated by the data generation section 614 by using the CAD data of the workpiece W and the like. Thereafter, the point data Dc is generated by the data generation section 614. In the process of generating the point data Dc, the data generation section 614 generates the point data Dc indicating the ideal scanning path as the reference path based on the workpiece information Da.

Next, the detection operation MD is executed. In the detection operation MD, while operating the robot 200 by using the point data Dc indicating the ideal scanning path, as illustrated in FIG. 17, the position of the liquid discharge head 310 on the scanning path with respect to the workpiece W or the object O is detected by using the measurement information Dd which is the measurement result of the distance sensor 360.

Next, the data generation section 614 generates the point data Dc indicating the corrected path based on the detection result of the detection operation MD, that is, the actual scanning path RUa. Then, the printing operation MP is performed on the workpiece W by using the point data Dc indicating the corrected path, and an image based on the print data Img is formed on the surface of the workpiece W.

In the three-dimensional object printing method using the three-dimensional object printing apparatus 100A, it is also possible to perform N times of detection operation MD and N times of printing operation MP according to the number of passes as in the first embodiment. As in the first embodiment, it is also possible to perform the confirmation operation MC between the detection operation MD and the printing operation MP.

As described above, the three-dimensional object printing apparatus 100A of the present embodiment further includes the distance sensor 360. The detection section 615A detects the position of the liquid discharge head 310 on the scanning path with respect to the object O with respect by using the measurement result of the distance sensor 360. Here, the position of the distance sensor 360 relative to the liquid discharge head 310 is fixed. Then, in the first detection operation MD_1, the distance sensor 360 measures the distance from the reference plane RF of which a position relative to the workpiece W is fixed. Therefore, it is possible to detect the position of the liquid discharge head 310 on the scanning path based on the measurement result of the distance sensor 360 without actually discharging the ink from the liquid discharge head 310. As a result, the amount of ink used can be reduced as compared with the configuration in which the detection pattern is printed as described in the first embodiment. When the object O is not used, it is possible to prevent the detection pattern from affecting the image formed on the workpiece W as compared with the configuration in which the detection pattern is printed as described in the first embodiment.

In the present embodiment, in the first detection operation MD_1, the detection axis AS of the distance sensor 360 intersects the scanning direction DS of the liquid discharge head 310. Therefore, it is possible to detect the position of the liquid discharge head 310 on the scanning path based on the measurement result of the distance sensor 360. In particular, when the detection axis AS of the distance sensor 360 intersects not only the scanning direction DS of the liquid discharge head 310 but also the ink discharge direction from the liquid discharge head 310, for example, when the detection axis AS is along the X-axis as in the present embodiment, there is an advantage that the deviation of the scanning path meandering with respect to the reference path RU_1 can be easily detected with high accuracy.

### 3. Modification Examples

The embodiments in the above examples can be variously modified. Specific modification aspects applicable to each of the above-mentioned embodiments are illustrated below. It should be noted that two or more aspects randomly selected from the following examples can be appropriately merged without contradicting each other.

### 3-1. Modification Example 1

Although the configuration using the 6-axis vertical articulated robot as the moving mechanism is illustrated in the above-described embodiments, the present disclosure is not limited to this configuration. The moving mechanism can change the position and pose of the liquid discharge head relative to the workpiece in three dimensions. Accordingly, the moving mechanism may be, for example, a vertical articulated robot other than the 6-axis robot, or may be a horizontal multi-axis robot. A movable portion of the robot arm is not limited to a rotating mechanism, and may be, for example, an expansion and contraction mechanism or the like. Alternatively, the robot arm does not have to be used as long as the position of the liquid discharge head can be changed three-dimensionally.

### 3-2. Modification Example 2

In the above-described embodiments, a configuration using screwing or the like as a method for fixing the liquid discharge head to the tip of the robot arm is exemplified, but the configuration is not limited to this configuration. For example, the liquid discharge head may be fixed to the tip of the robot arm by gripping the liquid discharge head by a gripping mechanism such as a hand attached to the tip of the robot arm.

### 3-3. Modification Example 3

Although the moving mechanism having the configuration for moving the liquid discharge head is illustrated in the above-described embodiments, the present disclosure is not limited to this configuration. For example, the position of the liquid discharge head may be fixed, the workpieces may be moved by the moving mechanism, and a position and a pose of the workpiece relative to the liquid discharge head may be changed three-dimensionally. In this case, for example, the workpiece is gripped by a gripping mechanism such as a hand attached to the tip of the robot arm.

### 3-4. Modification Example 4

Although a configuration in which printing is performed by using one type of ink is illustrated in the above-described embodiments, the present disclosure is not limited to this configuration, and is applicable to a configuration in which printing is performed by using two or more types of ink.

### 3-5. Modification Example 5

The application of the three-dimensional object printing apparatus of the present disclosure is not limited to printing. For example, a three-dimensional object printing apparatus that discharges a solution of a coloring material is used as a manufacturing apparatus that forms a color filter of a liquid crystal display apparatus. A three-dimensional object printing apparatus that discharges a solution of a conductive material is used as a manufacturing apparatus for forming a wiring and an electrode on a wiring substrate. The three-dimensional object printing apparatus can also be used as a jet dispenser for applying a liquid such as an adhesive to a workpiece.

What is claimed is:

1. A three-dimensional object printing apparatus comprising:
a liquid discharge head that discharges a liquid to a three-dimensional workpiece;
a moving mechanism that changes a position of the liquid discharge head relative to the workpiece or an object corresponding to the workpiece; and
a detection section that detects the position of the liquid discharge head relative to the workpiece or the object, wherein
the apparatus executes
a first detection operation in which the detection section detects a position on the first scanning path while the moving mechanism causes the liquid discharge head to scan relative to the workpiece or the object along a first scanning path, and
a first printing operation in which the liquid discharge head discharges the liquid to a first region of the workpiece while the moving mechanism causes the liquid discharge head to scan relative to the workpiece along a second scanning path based on a detection result by the detection section in the first detection operation.

2. A three-dimensional object printing apparatus comprising:
a liquid discharge head that discharges a liquid to a three-dimensional workpiece;
a moving mechanism that changes a position of the liquid discharge head relative to the workpiece or an object corresponding to the workpiece; and
a detection section that detects the position of the liquid discharge head relative to the workpiece or the object, wherein
the apparatus executes
a first detection operation in which the detection section detects a position on the first scanning path while the moving mechanism causes the liquid discharge head to scan relative to the workpiece or the object along a first scanning path, and
a first printing operation in which the liquid discharge head discharges the liquid to a first region of the workpiece while the moving mechanism causes the liquid discharge head to scan relative to the workpiece along a second scanning path,
when a deviation amount of the first scanning path with respect to a reference path is a first amount, a path difference between the first scanning path and the second scanning path is a first path difference, and
when the deviation amount is a second amount larger than the first amount, the path difference is a second path difference larger than the first path difference.

3. The three-dimensional object printing apparatus according to claim 1, wherein
in the first detection operation, the liquid discharge head forms a first detection pattern by discharging the liquid to the workpiece or the object, and the detection section detects the position on the first scanning path by detecting the first detection pattern.

4. The three-dimensional object printing apparatus according to claim 3, further comprising:
an imaging device, wherein
the detection section detects a position of the liquid discharge head on a scanning path with respect to the workpiece or the object by using an imaging result of the imaging device,
the first detection pattern includes a plurality of marks disposed at intervals from each other, and
the imaging device images the first detection pattern at an angle of view including two or more of the plurality of marks.

5. The three-dimensional object printing apparatus according to claim 4, wherein
a position of the imaging device with respect to the liquid discharge head is fixed.

6. The three-dimensional object printing apparatus according to claim 3, wherein
between the first detection operation and the first printing operation, the apparatus further executes
a second detection operation in which the detection section detects a position on the third scanning path while the moving mechanism causes the liquid discharge head to scan relative to the workpiece or the object along a third scanning path, and
a second printing operation in which the liquid discharge head discharges the liquid to a second region that partially overlaps the first region of the workpiece while the moving mechanism causes the liquid discharge head to scan relative to the workpiece along a fourth scanning path based on the detection result by the detection section.

7. The three-dimensional object printing apparatus according to claim 6, wherein
in the second detection operation, the liquid discharge head forms a second detection pattern at a position deviated from the first detection pattern in a scanning direction of the liquid discharge head by discharging the liquid to the workpiece or the object, and the detection section detects the position on the third scanning path by detecting the second detection pattern.

8. The three-dimensional object printing apparatus according to claim 7, wherein
shapes or colors of the first detection pattern and the second detection pattern are different from each other.

9. The three-dimensional object printing apparatus according to claim 3, wherein
an amount of the liquid to be used to form the first detection pattern is smaller than an amount of the liquid to be used to execute the first printing operation.

10. The three-dimensional object printing apparatus according to claim 1, wherein
between the first detection operation and the first printing operation, the apparatus further executes a confirmation operation in which the detection section detects a position on the scanning path while the moving mechanism causes the liquid discharge head to scan relative to the workpiece or the object along a scanning path based on the detection result by the detection section in the first detection operation for the workpiece or the object.

11. The three-dimensional object printing apparatus according to claim 1, further comprising:
a distance sensor, wherein
the detection section detects a position of the liquid discharge head on a scanning path with respect to the workpiece by using a measurement result of the distance sensor,
a position of the distance sensor relative to the liquid discharge head is fixed, and
in the first detection operation, the distance sensor measures a distance to a reference plane of which a position relative to the workpiece is fixed.

12. The three-dimensional object printing apparatus according to claim 11, wherein
in the first detection operation, a detection axis of the distance sensor intersect a scanning direction of the liquid discharge head.

13. The three-dimensional object printing apparatus according to claim 1, wherein
the moving mechanism is an articulated robot to which an end effector including the liquid discharge head is attached, and
the articulated robot is coupled to a robot controller.

14. The three-dimensional object printing apparatus according to claim 13, further comprising:
a data generation section that generates point data indicating a position where the liquid discharge head should pass, wherein
the robot controller controls driving of the articulated robot based on the point data from the data generation section, and
the data generation section generates point data to be used in the first printing operation based on the detection result of the detection section in the first detection operation.

15. The three-dimensional object printing apparatus according to claim 14, wherein
the data generation section generates point data to be used for the first printing operation by correcting the point data used in the first detection operation so that the second scanning path is closer to a reference path than the first scanning path, based on the detection result of the detection section in the first detection operation.

16. The three-dimensional object printing apparatus according to claim 15, wherein
the data generation section corrects the point data used in the first detection operation so that the position where the liquid discharge head should pass is shifted in a direction intersecting the first scanning path, based on the detection result of the detection section in the first detection operation.

17. A three-dimensional object printing method for printing on a three-dimensional workpiece by using a liquid discharge head that discharges a liquid to the workpiece and a moving mechanism that changes a position of the liquid discharge head relative to the workpiece or an object corresponding to the workpiece, the method comprising:
executing a first detection operation of detecting a position on the first scanning path while the moving mechanism causes the liquid discharge head to scan relative to the workpiece or the object along a first scanning path; and
executing a first printing operation in which the liquid discharge head discharges the liquid to a first region of the workpiece while the moving mechanism causes the liquid discharge head to scan relative to the workpiece along a second scanning path based on a detection result by the detection section in the first detection operation.

18. The three-dimensional object printing method according to claim 17, wherein
the moving mechanism causes the liquid discharge head to scan the object in the first detection operation,
a shape of the object is substantially the same as a shape of the workpiece, and
the object is replaced with the workpiece between the first detection operation and the first printing operation.

19. The three-dimensional object printing method according to claim 17, wherein
the moving mechanism causes the liquid discharge head to scan the workpiece in the first detection operation.
